(19) United States
(12) Patent Application Publication
(10) Pub. No.: US 2024/0002550 A1
(43) Pub. Date: Jan. 4, 2024

(54) Process for the treatment of biomass

(71) Applicant: Politecnico di Milano, Milano MI (IT)

(72) Inventors: Andrea MELE, Milano MI (IT); Monica FERRO, Milano MI (IT); Greta COLOMBO DUGONI, Inveruno MI (IT)

(21) Appl. No.: 18/253,431

(22) PCT Filed: Nov. 15, 2021
(86) PCT No.: PCT/IB2021/060561

§ 371 Date: May 18, 2023

(30) Foreign Application Priority Data
Nov. 19, 2020 (IT) 102020000027840

(51) Int. Cl. C08B 37/00

(52) U.S. Cl. CPC C08B 37/0057

(57) ABSTRACT

Process for the treatment of lignocellulosic biomass with a process solvent selected from a eutectic solvent, an ionic liquid and/or a mixture of said eutectic solvent and said ionic liquid, comprising the following steps or stages:
A. Mixing the biomass with said process solvent and filtering the solid precipitate consisting of insoluble cellulosic residues;
B. Treating the process solvent mixture containing lignin and hemicellulose with water, precipitation of the lignin and separation of the latter;
C. Separating the hemicellulose from the process solvent;
   wherein
      in step A, water is added to said process solvent in weight ratios with respect to the process solvent between 80:20 and 20:80;
      in step B, water is added in amounts between 10 and 25 times the initial amount of DES added in step A, to precipitate the lignin, which is filtered, and the process comprises a stage D in which the water is removed from the filtrate by evaporation at pressures between 5 and 15 mbar, preferably 10 mbar;
   step C of separating the hemicellulose is carried out by addition of an organic solvent soluble in the process solvent mixture, thereby allowing the precipitation of the hemicellulose and the subsequent separation thereof by conventional techniques from the liquid phase consisting of the process solvent and the organic solvent.

### FIELD OF THE INVENTION

The present invention relates to a treatment and purification method of lignocellulosic products and possibly inorganic products from biomass.

### BACKGROUND ART

The treatment of biomass to obtain products of high industrial value fully falls within the concept of circular economy, which envisages an economy designed to be able to regenerate itself. In a circular economy, the material flows are of two types: biological, which can be reintegrated into the biosphere, and technical, which are destined to be revalued without entering the biosphere.^{[1]}

For example, rice generates a large amount of waste: for a ton of white rice, 1.3 tons of straw, 200 kilos of husk (often improperly called chaff)—the coating that encloses the grain—and 70 kilos of chaff, a residue that is obtained by bleaching the rice, when the outer layer of the grain is removed.^{[2]} Such materials are difficult to burn as they contain a significant amount of silica which damages the combustion plants.^{[3]}

Another material whose processing waste is of particular interest is the thistle from which the cellulose is extracted.^{[4,5]} Thistle has been identified as a low-input crop which is well suited to the climate of the Mediterranean regions. Furthermore, thistle seeds are used to extract oil from which high value-added products such as azelaic acid and pelargonic acid are obtained.

A further example of processing waste is beer processing waste, also called threshings. They make up about 85% of breweries' waste and the main components are cellulose (23-25%), hemicellulose (30-35%), lignin (11-27%) and protein (15-24%).^{[6,7]}

From the biomass that represents the process waste, lignin, hemicellulose and cellulose can be extracted and in the case of rice also silica.

In particular, although lignin constitutes 20% to 30% of the ground plant biomass, the major problem lies in the difficulty of separating it from the biomass itself. In fact, the known delignification process is an expensive process. Usually identified as a problem in the current transformation processes of plant biomass, lignin can instead become the raw material for a number of industrial applications: the production of vanillin, the aroma of vanilla used in the food, cosmetic and feed industry, and the production of fuel (ethanol, biodiesel). By virtue of its biodegradability and non-toxicity, lignin is used to produce granular soil improvers with controlled release of micronutrients. Alternatively, lignin can also be used as a dispersing agent in aqueous medium, once oxidized or sulfonated, as an emulsion stabilizer, metal sequestrant or surfactant.

Silica, SiO₂, represents the real problem in the rice waste treatment and enhancement process. Such material is normally used as raw material for the production of elemental silicon, used in the construction of integrated circuits, transistors and other electronic components. Having hardness 7 in the Mohs scale, silica is a relatively hard material, and therefore is used as an abrasive. Silica also finds application as an insulator (present, for example, also in the thermal shield of space probes or space shuttle), as a refractory material used in ovens, as a mixture of modern tyres, to reduce rolling resistance and improve wet grip, as an anti-caking agent in powdered foods and as an abrasive agent for the surface of teeth in toothpastes. Other applications of silica include analytical chemistry, for separating compounds by chromatography, in the pharmaceutical industry as a pill filler and for the production of aerogel. As for cellulose, it is mainly used in the production of paper. However, cellulose is also widely used in the pharmaceutical sector (production of gauze and coatings capable of modulating the release of active ingredients therefrom), cosmetics (gels, stabilizers, filming agents, toothpastes), textiles (rayon, lyocel), etc. Natural cellulose sponges can be used in many ways in the chemical industry: shipbuilding (to seal ducts in bulkheads), petrochemical industry (filtration processes), cooling systems (moisture absorption), cloths for cleaning surfaces. Since cellulose is insoluble in water, it is transformed into CarboxyMethylCellulose (CMC) through a chemical reaction in order to be industrially exploited in some applications. This transformation occurs through the introduction of the carboxymethyl substituent which transforms the cellulose, insoluble in organic solvents, into more water-soluble CMC. CMC finds application in many fields, especially by virtue of its thickening (it increases the viscosity of a solution) and floating (stays suspended in solid particle solutions), in addition to its adhesive and water retention capacity. The length of the CMC molecule (number of glucose units forming it) influences the viscosity of the solution and, therefore, the field of application. The main sectors of use of the CMC are: detergents, oil drilling, ceramics, paper supply chain, textile industry, paints and varnishes, food industry, cosmetics, pharmaceutical and pet food. At an industrial level, cellulose with high crystallinity (without the presence of hemicellulose and therefore with high purity) is an important product in the food and pharmaceutical field. Cellulose acetate is instead produced by reaction of the cellulose with acetic anhydride to make a very versatile polished polymer. It is often called “artificial silk” and used for the textile industry. It finds application above all in the manufacture of frames for eyeglasses and sunglasses. It can also be produced in thin transparent sheets, used for the production of protective masks, lamp shields and theatre projectors. Finally, nitrocellulose is the nitric ester of cellulose. Used for the flash of cameras in the past, today it finds application especially in the field of manufacturing of paints and enamels. It is used in protein analysis (Western blot), magic tricks and as a propellant for gun and rifle cartridges.

Finally, hemicellulose, which is difficult to separate from cellulose, is used for the production of furfural, which is used as a solvent in petrochemicals to extract dienes (such as those used to produce synthetic rubber) from other hydrocarbons. Furfural is also used for the preparation of solid resins, for the production of fibreglass for aeronautical components and for brakes. It can also be used for the production of Nylon, a process which has already been implemented in the past, but which, precisely because of the difficult separation from hemicellulose, was industrially expensive with poor yields in the desired product.

Various processes are known from the state of the art for the separation of cellulosic material from biomass by means of the use of eutectic solvents. For example, the most recent such method is described in WO 2017032926, which contemplates treating biomass containing a certain amount of hemicellulose, lignin or a combination thereof by means of the addition of a eutectic solvent. In particular, the eutectic solvents chosen hereinabove are for example a combination of a (2-R-ethyl)-trimethylammonium salt with boric acid, meta-boric acid, boronic acid, borinic acid, alkyl borates, hydrated borate salts or purified acid. The R group, indicated above, is selected from OH, halogens, ester groups, ether groups or carbamoyl. Furthermore, a certain amount of water is added to the mixture of biomass and solvent at a temperature between 40° C. and 100° C. Thereafter, the aqueous mixture of the biomass is divided into a liquid fraction, a solid fraction and a fraction containing unsolubilized fibres. In particular, the liquid fraction contains hemicellulose and the eutectic solvent, while the solid fraction contains the precipitated lignin.

The known art described above presents a series of problems, as it does not allow the complete separation of the elements constituting the biomass, in particular lignin, hemicellulose and cellulose. Furthermore, this process does not allow the complete separation of the eutectic solvent from the reaction products; consequently, the recycling of the eutectic solvent used is problematic.

### SUMMARY OF THE INVENTION

The applicant has found a method for the treatment of lignocellulosic biomass which is able to overcome the drawbacks of the prior art so as to allow the purification of the biomass by means of an economical process and with low environmental impact.

The object of the present invention is therefore a process for the treatment of lignocellulosic biomass with a process solvent selected from a eutectic solvent, consisting of a hydrogen bond acceptor and a hydrogen bond donor, an ionic liquid or a mixture of said eutectic solvent and said ionic liquid, comprising the following steps or stages:
A. Mixing the biomass with said process solvent and filtering the solid precipitate consisting of insoluble cellulosic residues;
B. Treating the process solvent mixture containing lignin and hemicellulose with water, precipitation of the lignin and separation of the latter;
C. Separating the hemicellulose from the process solvent;
in which:
   in step A, water is added to said process solvent in weight ratios with respect to the process solvent between 80:20 and 20:80, preferably 75:25;
   in step B, water is added in amounts between 10 and 25 times the initial amount of DES added in step A, to precipitate the lignin, which is filtered, and the process comprises a stage D in which the water is removed from the filtrate by evaporation at pressures between 5 and 15 mbar, preferably 10 mbar;
   step C of separating the hemicellulose from the DES is carried out by addition of an organic solvent soluble in the process solvent mixture, thereby allowing the precipitation of the hemicellulose and the subsequent separation thereof by conventional techniques from the liquid phase comprising the process solvent and the organic solvent.

In particular, such a process makes it possible to obtain products with high added value, in an economical manner and with low environmental impact. Advantageously, the steps according to the present invention allow to separate, with a high degree of purity, the components of the biomass, while simultaneously allowing a separation of the solvent, initially used in the reaction mixture, which can be recycled in the process.

### DESCRIPTION OF THE FIGURES

FIG. 1 depicts a preferred embodiment of the process of the invention, in which a lignocellulosic biomass chosen from thistle or threshing processing waste or cellulose obtained through the Kraft process is used as the starting material.

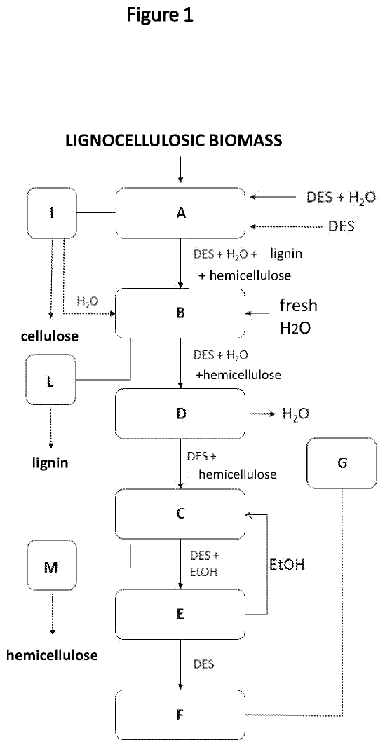

FIG. 2 depicts a preferred embodiment of the process of the invention, in which a lignocellulosic biomass from the processing waste of rice husk or straw is used as the starting material.

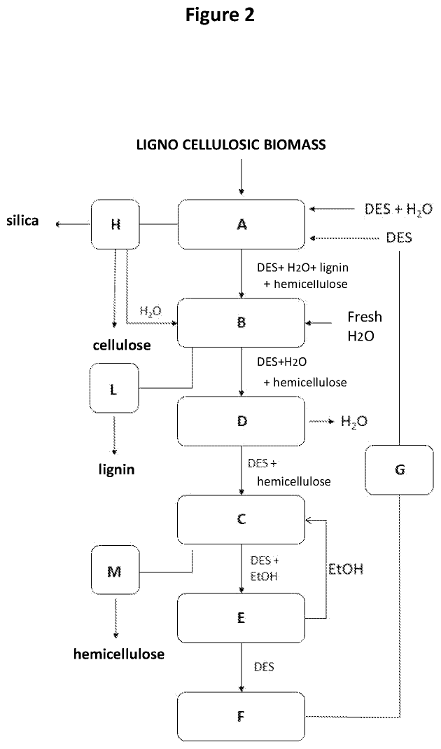

### DETAILED DESCRIPTION

For the purposes of the present invention, the term “comprising” does not exclude the possibility that the process of the invention comprises further stages or steps in addition to those expressly stated, while the terms “consisting in” or “consisting of” exclude such a possibility.

For the purposes of the present invention, lignocellulosic biomass means all types of biomass comprising at least hemicellulose, cellulose, lignin and optionally a mineral component such as silica.

This category of biomass includes not only processing waste, such as those from the processing of soft wood, hard wood, straw, cane, hemp, sisal, flax, ramie, jute, agave, kenaf, rosella, urena, acaba, coconut, corn, cane, bagasse, banana, soybean, palm oil, cotton, sugar beet, olives, grapes and fruit, rice, thistle, threshing, malt and combinations thereof, but also industrial products such as the cellulose obtained through the Kraft industrial process, which for some uses requires further refining treatments. Preferably, in the process of the invention the lignocellulosic biomass consists of waste from the processing of rice, such as for example the husk and the straw, comprising a high percentage of silica, or of thistle, which vice versa is free of silica or is the cellulose from the Kraft process.

Preferably, when the lignocellulosic biomass is Kraft cellulose, it is added, in step A, to the mixture of process solvent and water in amounts between 4 and 10%, preferably 5% by weight on the total weight of the stage A mixture.

The water in stage A is preferably added with respect to the organic solvent in weight ratios between 25:75 and 75:25.

Stage A of the process of the invention is preferably conducted at a temperature between 40 and 100° C., more preferably between 60 and 90° C., more preferably between 70 and 85° C., even more preferably the mixing is conducted at 80° C.

The times at which stage A is performed are preferably between 20 and 24 hours.

For the purposes of the present invention, the process solvent can consist of a eutectic solvent, an ionic liquid or a combination of the eutectic solvent and the ionic liquid.

For the purposes of the present invention, eutectic solvents mean so-called deep eutectic solvents or DES. In other words, it is a combination of a hydrogen bond acceptor and a hydrogen bond donor. Preferably, the hydrogen bond acceptor is choline acetate, while the hydrogen bond donor is selected from glycolic acid, diglycolic acid, levulinic acid and imidazole. In a particularly preferred form, the DES used is the combination of choline acetate and glycolic acid or choline acetate and levulinic acid.

For the purposes of the present invention, ionic liquid used as a process solvent means the product resulting from the following reaction:

choline acetate+X—H=choline X⁻+CH₃COOH

where X⁻ is the anion of an organic weak acid preferably selected from glycolic acid, diglycolic acid, levulinic acid. In particular, the ionic liquid consists of a liquid system containing the choline ion in the presence of the conjugate base of glycolic acid, or diglycolic acid or levulinic acid. In a particularly preferred embodiment, the ionic liquid used consists of cholinium glycolate.

The reaction for the production of the ionic liquid is preferably conducted in a temperature range between 40 and 100° C., more preferably between 60 and 90° C., still more preferably between 70 and 85° C. and according to a particularly preferred embodiment at 80° C. Furthermore, the ratio of the reagents is preferably 1:1.

Advantageously, the process solvents used are halogen-free, facilitating disposal at an industrial level.

The use of the aforementioned hydrogen bond acceptors and donors allows the preparation of DES by simple mixing of the two components at room temperature and pressure, reducing the costs and production times thereof.

The DES can in turn react, giving rise to the above-mentioned ionic liquid. Since the ionic liquid formation reaction is an equilibrium reaction, this explains the fact that the process solvent is preferably a mixture of DES and ionic liquid.

According to the present invention, the weight ratios of the components of the eutectic solvent, hydrogen bond acceptor and donor are preferably between 1:5 and 5:1, more preferably from 1:3 to 3:1, even more preferably from 1:2 to 2:1 and according to a particularly preferred solution said ratio is 1:1.

In step B, to facilitate the precipitation of the lignin, water is added in considerable amounts with respect to the DES in step A, in a weight ratio between 10:1 and 25:1. The water added in step B also comes in part from washing the cellulose or step I of the process of the invention, in the case where the lignocellulosic biomass does not contain inorganic material.

When rice husk and straw are used in the process of the invention, the process preferably comprises a step H of separating the cellulose from the silica. Preferably, step H includes an initial step of washing the precipitate, comprising silica and cellulose, with water. In particular, the washing is repeated at least from 1 to 10 times, preferably 6 times so as to facilitate the elimination of any residues of the process solvent within the silica and cellulose mixture. Subsequently, step H includes centrifuging the aqueous mixture to allow to obtain three distinct phases: the heaviest phase is the cellulose, the intermediate phase is the silica and supernatant, the surface phase consists of water. Thereby, the process according to the present invention allows to recover the silica and cellulose from the biomass, while the supernatant phase consisting of the water is added in stage B.

After the separation of the lignin in stage B. The filtrate therefore contains process solvent, water and hemicellulose. The process of the invention thus comprises a stage D, in which the water from stage B is removed before stage C. In stage C, a protic polar solvent, preferably a linear or branched C1-C6 alcohol, and even more preferably ethanol, is added.

Thereby, the hemicellulose precipitates and us separated from the process solvent and organic solvent. The organic solvent is preferably added in volumetric ratios between 10:1 and 1:1, more preferably between 5:1 and 1:1.

The process of the invention preferably also contemplates a stage E in which the organic solvent is removed by evaporation, at pressures between 1 bar and 20 mbar, preferably 10 mbar, the final liquid phase from stage E essentially consists of the process solvent, which in stage F is collected, recycled in step A.

According to a further preferred embodiment of the process according to the present invention, also ethanol evaporated in stage E, possibly condensed and collected in stage G, is recycled in stage C.

For the purposes of the present invention, process solvent and water-soluble organic solvent means a polar solvent, preferably a protic polar solvent, even more preferably a linear or branched C₁-C₅ aliphatic alcohol, most preferably ethanol.

Advantageously, the separation of the hemicellulose from the reaction mixture containing the process solvent allows to obtain the same in a purer form. Thereby, the hemicellulose can be treated with conventional processes to make high added value products such as furfural in optimal yields.

According to a preferred embodiment of the process of the invention, stage B comprises a step L of glass filtration of the lignin and washing the precipitate with ethanol and cation exchange resin, even more preferably Amberlite IR120.

According to another preferred embodiment, also stage C can comprise a step M of glass filtration of the hemicellulose and washing the hemicellulose with water and cation exchange resin, even more preferably Amberlite IR120.

Preferably, the processing process comprises a step prior to step A in which the biomass is ground, and if the biomass has a high water content, is preferably dried. In particular, the grinding step reduces the biomass to be treated to powder with a particle size distribution between 0.04 mm and 2 mm.

Advantageously, grinding the biomass facilitates the mixing with the process solvent and alcohol, as well as the subsequent separation steps.

The degree of purity of the cellulose is expressed as an increase in the crystallinity of the cellulose with respect to the starting biomass. The crystallinity is measured with X-ray powder diffractometry.

Advantageously, the recycling of the process solvent and ethanol reduces the material costs and the environmental impact of the process according to the invention.

Laboratory examples are provided below for non-limiting purposes in order to better clarify the different steps of the process according to the invention and the products with high added value obtained.

### Example 1

In this example 500 mg of Kraft cellulose, 7.5 g of DES choline acetate combined with levulinic acid were used as biomass, in molar ratio 1:1 and 2.5 g water.

### Step A:

mixing DES/water with Kraft cellulose for 24 h at 80° C.;
filtering the mixture and obtaining a cellulose precipitate of 452 mg and a mixture of DES, water, hemicellulose and lignin.

### Step I:

washing the precipitate with 200 ml water at room temperature, the mixture containing water and DES is used in step B of the process.

### Step B:

adding both washing water from step I described above and additional 120 g of new water;
separating the lignin in an amount equal to 9 mg and obtaining a mixture containing DES, water and hemicellulose.

### Step D:

low pressure (10 mbar) removal of water from the mixture from step B.

### Step C:

mixing 20 ml of ethanol with the mixture of DES and hemicellulose obtained from step I;
precipitating hemicellulose from the mixture;
centrifuging the aqueous mixture;
separating hemicellulose and the relative recovery in an amount of 19 mg.

### Step E:

evaporating under reduced pressure ethanol from the mixture containing DES and ethanol obtained in step C.

### Step F

6.9 g of DES is recovered.

A cellulose with a degree of crystallinity of 60% is obtained.

### Example 2

In this example 500 mg of Kraft cellulose, 5 g of DES choline acetate combined with levulinic acid were used as biomass, in molar ratio 1:1 and 5 g water.

### Step A:

mixing DES/water with Kraft cellulose for 24 h at 80° C.;
filtering the mixture and obtaining a cellulose precipitate of 453 mg and a mixture of DES, water, hemicellulose and lignin.

### Step I:

washing the precipitate with 200 ml water at room temperature, the mixture containing water and DES is used in step B of the process.

### Step B:

adding both washing water from step I described above and additional 80 g of new water
separating the lignin in an amount equal to 7 mg and obtaining a mixture containing DES, water and hemicellulose.

### Step D:

low pressure (10 mbar) removal of water from the mixture from step B.

### Step C:

mixing 20 ml of ethanol with the mixture of DES and hemicellulose from step I;
precipitating hemicellulose from the mixture;
centrifuging the aqueous mixture;
separating hemicellulose and the relative recovery in an amount of 18 mg.

### Step E:

evaporating under reduced pressure ethanol from the mixture containing DES and ethanol obtained in step C;

### Step F

recovery of DES in an amount of 1.7 g.

A cellulose with a degree of crystallinity of 64% is obtained.

### Example 3

In this example 1 g of Kraft cellulose, 2.5 g of DES choline acetate combined with levulinic acid, in a 1:1 molar ratio and 7.5 g water were used as biomass.

### Step A:

mixing DES/water with Kraft cellulose for 24 h at 80° C.;
filtering the mixture and obtaining a cellulose precipitate of 925 mg and a mixture of DES, water, hemicellulose and lignin.

### Step I:

washing the precipitate with 350 ml water at room temperature, the mixture containing water and DES is used in step B of the process.

### Step B:

water is added from the cellulose washing step I and 40 g of new water is added and lignin is separated in an amount of 28 mg and a mixture of DES, water and hemicellulose is obtained.

### Step D:

low pressure removal (10 mbar) of water from the mixture of step B and obtaining a mixture of DES and hemicellulose

### Step C:

mixing 20 ml of ethanol with the mixture of DES and hemicellulose from step D;
precipitating hemicellulose from the mixture;
centrifuging the aqueous mixture;
separating hemicellulose and the relative recovery in an amount of 35 mg.

### Step E:

evaporating under reduced pressure the mixture containing DES and ethanol obtained in step C.

### Step F:

recovery of DES in an amount of 2.1 g.

A cellulose with a degree of crystallinity of 60% is obtained.

### Example 4

In this example 500 mg of Kraft cellulose, 2.5 g of DES choline acetate combined with levulinic acid were used as biomass, in molar ratio 1:1 and 7.5 g water.

### Step A:

mixing DES/water with Kraft cellulose for 24 h at 80° C.;
filtering the mixture and obtaining a cellulose precipitate of 452 mg and a mixture of DES, water, hemicellulose and lignin.

### Step I:

washing the precipitate with 200 ml water at room temperature, the mixture containing water and DES is used in step B of the process.

### Step B:

adding 120 g of new water and washing water from step I to the mixture of DES, hemicellulose water and lignin.
separating the lignin in an amount equal to 12 mg and obtaining a mixture containing DES, water and hemicellulose.

### Step D:

low pressure (10 mbar) removal of water from the mixture from step B.

### Step C:

mixing 20 ml of ethanol with the mixture of DES and hemicellulose from step I;
precipitating hemicellulose from the mixture;
centrifuging the aqueous mixture;
separating hemicellulose and the relative recovery in an amount of 21 mg.

### Step E:

evaporating under reduced pressure ethanol from the mixture containing DES and ethanol from step C of only ethanol.

### Step F:

recovery of DES in an amount of 3.7 g.

A cellulose with a degree of crystallinity of 65% is obtained.

### Example 5

In this example 500 mg of biomass from brewing waste (threshings) and 2.5 g of DES choline acetate combined with levulinic acid were used, in a 1:1 molar ratio and 2.5 g of water.

### Step A:

preparing 500 mg of dried and ground threshings
mixing DES/water with the threshings for 24 h at 80° C.;
centrifuging the mixture and obtaining a cellulose precipitate and a mixture of DES, hemicellulose and lignin.

### Step I:

washing the cellulose precipitate six times with water at room temperature, the mixture containing water and DES is used in step B of the process;
centrifuging the aqueous mixture;
separating the cellulose from the aqueous mixture, obtaining 222 mg of cellulose with a 35% increase in the degree of crystallinity with respect to the starting biomass.

### Step B:

adding a certain amount of water equal to 10 ml, comprising the washing water from step I to the mixture containing DES, water, lignin and hemicellulose;
centrifuging the aqueous mixture;
separating the lignin and obtaining a mixture containing DES, water and hemicellulose.

### Step D:

low pressure (10 mbar) removal of water from the mixture from step B.

### Step C:

mixing a certain amount equal to 4 ml of ethanol to the mixture of DES and hemicellulose from step I;
precipitating hemicellulose from the mixture;
centrifuging the aqueous mixture;
separating the hemicellulose.

### Step E:

evaporating under reduced pressure ethanol from the mixture containing DES and ethanol obtained in step C;

### Step F

recovery of DES.

### Example 6

In this example 1 g of biomass from brewing waste (threshings) and 7.5 g of DES choline acetate combined with levulinic acid were used, in a 1:1 molar ratio and 2.5 g of water.

### Step A:

preparing 1 g of dried and ground threshings
mixing DES/water with the threshings for 24 h at 80° C.;
centrifuging the mixture and obtaining a 717 mg cellulose precipitate and a mixture of DES, water, hemicellulose and lignin.

### Step I:

washing the cellulose precipitate six times with water at room temperature, the mixture containing water and DES is used in step B of the process;
centrifuging the aqueous mixture;
separating the cellulose from the aqueous mixture, obtaining a cellulose with a 33% increase in the degree of crystallinity with respect to the starting biomass.

### Step B:

adding a certain amount of water equal to 20 ml including also the water from the washing of the cellulose to the mixture containing DES, lignin and hemicellulose;
centrifuging the aqueous mixture;
separating the lignin and obtaining a mixture containing DES, water and hemicellulose.

### Step D:

low pressure (10 mbar) removal of water from the mixture from step B.

### Step C:

mixing a certain amount equal to 20 ml of ethanol to the mixture of DES and hemicellulose obtained from step I;
precipitating hemicellulose from the mixture;
centrifuging the aqueous mixture;
separating a certain amount of hemicellulose.

### Step E:

evaporating under reduced pressure ethanol from the mixture containing DES and ethanol obtained in step C.

### Step F

recovery of DES.

### Example 7

In this example 1 g of biomass from brewing waste (threshings) and 2.5 g of DES choline acetate combined with levulinic acid were used, in a 1:1 molar ratio and 7.5 g of water.

### Step A:

preparing 1 g of dried and ground threshings
mixing DES/water with the threshings for 24 h at 80° C.;
centrifuging the mixture and obtaining a 719 mg cellulose precipitate and a mixture of DES, hemicellulose and lignin.

### Step I:

washing the cellulose precipitate six times with water at room temperature, the mixture containing water and DES is used in step B of the process;
centrifuging the aqueous mixture;
separating the cellulose from the aqueous mixture obtaining a cellulose with a 28% increase in the degree of crystallinity with respect to the starting biomass.

### Step B:

adding a certain amount of water equal to 20 ml including the washing water of the cellulose from stage I to the mixture containing DES, water, lignin and hemicellulose, precipitate hemicellulose;
centrifuging the aqueous mixture;
separating the lignin and obtaining a mixture containing DES, water and hemicellulose.

### Step D:

low pressure (10 mbar) removal of water from the mixture from step B.

### Step C:

mixing a certain amount equal to 20 ml of ethanol to the mixture of DES and hemicellulose obtained from step B;
precipitating hemicellulose from the mixture;
centrifuging the aqueous mixture;
separating a certain amount of hemicellulose.

### Step E:

evaporating under reduced pressure the mixture containing DES and ethanol obtained in step C.

### Step F

recovery of DES.

### BIBLIOGRAPHY

ADDIN Mendeley Bibliography CSL_BIBLIOGRAPHY [1] R. Abejón, H. Pérez-Acebo, L. Clavijo, Processes 2018, 6, 98.
[2] J. Wu, A. Elliston, G. Le Gall, I. J. Colquhoun, S. R. A. Collins, I. P. Wood, J. Dicks, I. N. Roberts, K. W. Waldron, Biotechnol. Biofuels 2018, 11, 62.
[3] L. Ludueña, D. Fasce, V. A. Alvarez, P. M. Stefani, BioResources 2011, 6, 1440-1453.
[4] M. C. Fernandes, M. D. Ferro, A. F. C. Paulino, J. A. S. Mendes, J. Gravitis, D. V. Evtuguin, A. M. R. B. Xavier, Bioresour. Technol. 2015, 186, 309-315.
[5] A. A. Shatalov, H. Pereira, Chem. Eng. Res. Des. 2014, 92, 2640-2648.
[6] S. Aliyu, Bala, African J. Biotechnol. 2008, 10, 324-331.
[7] P. K. Mishra, T. Gregor, R. Wimmer, BioResources 2017, 12, 107-116.

1. A process for the treatment of lignocellulosic biomass with a process solvent selected from a eutectic solvent, consisting of a hydrogen bond acceptor and a hydrogen bond donor, an ionic liquid and a mixture of said eutectic solvent and said ionic liquid,
comprising the following steps:
A. Mixing the biomass with said process solvent and filtering the solid precipitate consisting of insoluble cellulosic residues;
B. Treating the process solvent mixture containing lignin and hemicellulose with water, precipitating lignin and separating the latter;
C. Separating the hemicellulose from the process solvent mixture;
wherein
in step A, water is added to said process solvent in weight ratios with respect to the process solvent between 80:20 and 20:80;
in step B, water is added in amounts between 10 and 25 times the initial amount of water added in step A, to precipitate the lignin, which is filtered, and the process comprises a stage D in which the water is removed from the filtrate by evaporation at pressures between 5 and 15 mbar;
step C of separating the hemicellulose is carried out by addition of an organic solvent soluble in the process solvent mixture, thereby allowing the precipitation of the hemicellulose and the subsequent separation thereof by conventional techniques from the liquid phase comprising the process solvent and the organic solvent.

2. Process according to claim 1, comprising a step E in which the organic solvent is removed from the stage C filtrate.

3. Process according to claim 2, comprising a stage G in which the organic solvent, removed by evaporation in stage E, is recycled in stage C.

4. Process according to claim 1, wherein the hydrogen bond acceptor and donor are halogen-free, the hydrogen bond acceptor is choline acetate and the hydrogen bond donor is selected from: glycolic acid, diglycolic acid, levulinic acid and imidazole.

5. Process for the treatment of biomass according to claim 1, wherein the weight ratio of the hydrogen bond acceptors to hydrogen bond donors of the halogen-free eutectic solvent is at least 1:5 to 5:1.

6. Process according to claim 1, wherein the ionic liquid is the product resulting from the reaction of: choline acetate+X—H=choline X⁻+CH3COOH where X is the anion of a weak organic acid preferably selected from glycolic acid, diglycolic acid, levulinic acid.

7. Process according to claim 1, wherein the lignocellulosic biomass is from the processing waste of rice, thistle, or threshing, or it is Kraft cellulose.

8. Process according to claim 7, wherein, when said rice processing waste is selected from husk and straw, step A comprises a step H of separating the silica and cellulose from the solution, comprising in turn:
washing the precipitate, comprising silica and cellulose, with water 1 to 10 times.
centrifuging the aqueous mixture to allow to obtain three distinct phases: the heaviest phase is the cellulose, the intermediate phase is the silica and supernatant, the surface phase consists of water, which is sent to stage B.

9. Process according to claim 7, wherein when the lignocellulosic biomass is chosen from thistle or threshing waste, or is Kraft cellulose, stage A comprises a stage I in which the cellulose is washed and the washing water is added in stage B.

10. Process according to claim 7, wherein, when the lignocellulosic biomass is cellulose from the Kraft process, it is added in amounts between 4 and 10%.

11. Process according to claim 1, wherein the mixing temperature in step A is between 40 and 100° C.

12. Process according to claim 1, wherein the mixing in step A is carried out for a time between 20 and 24 hours.

13. Process for the treatment of biomass according to claim 1, wherein in step C the organic solvent soluble in water is a protic polar solvent.

14. Process for the treatment of biomass according to claim 1, wherein step B comprises a step L of glass filtration of the lignin and washing the precipitate with ethanol and cation exchange resin.

15. Process for the treatment of biomass according to claim 1, wherein step C comprises a step M of glass filtration and washing the hemicellulose with water and ion exchange resin.

16. Process according to claim 2, comprising further step F in which the DES from step E is recycled in stage A.

17. Process according to claim 4, wherein the hydrogen bond donor is selected from glycolic acid or levulinic acid.

18. Process according to claim 5, wherein weight ratio of the hydrogen bond acceptors to hydrogen bond donors of the halogen-free eutectic solvent is 1:3 to 3:1.

19. Process according to claim 5, wherein weight ratio of the hydrogen bond acceptors to hydrogen bond donors of the halogen-free eutectic solvent is 1:2 to 2:1.
